(19) United States
(12) Patent Application Publication
(10) Pub. No.: US 2025/0269212 A1
(43) Pub. Date: Aug. 28, 2025

(54) Expanding Rapid Expansion Fire Stop for Wall Openings

(71) Applicant: Adam S Marschinke, Fishers, IN (US)

(72) Inventor: Adam S Marschinke, Fishers, IN (US)

(21) Appl. No.: 19/064,191

(22) Filed: Feb. 26, 2025

Related U.S. Application Data
(60) Provisional application No. 63/557,947, filed on Feb. 26, 2024.

(51) Int. Cl. A62C 2/06

(52) U.S. Cl. CPC A62C 2/065

(57) ABSTRACT

A device that is an improved rapid expansion fire stop and system for wall openings. The fire stop is made of a backer rod comprised of a durable foam material in a pre-determined size and cross-sectional configuration, the backer rod has a slot that accepts an intumescent strip with expansion characteristics of expanding up to thirty-three (33) times its size and volume when exposed to high heat or flame. The firestop is placed into the wall opening or crack of the wall system and then the wall system is completed with an architectural sealant across the remaining crack. The improved expanding rapid expansion fire stop serves to prevent fire, smoke and heat by expanding and fully sealing the wall opening and crack from any intrusion or passage of the heat, smoke or flame through the opening.

### CROSS-REFERENCE TO RELATED APPLICATIONS

This application claims the benefit of U.S. Provisional Patent Application with Serial Number 63/557,947 filed Feb. 26, 2023, by Adam S. Marschinke. The provisional application is entitled “Improved Expanding Rapid Expansion Fire Stop for Wall Openings”.

### FIELD OF INVENTION

The present invention relates to an Improved Rapid Expansion Fire Stop and System for Wall Openings. This application is directed toward fire-rated wall construction components for use in building construction. It relates generally to expansion joints and more particularly, it relates to fire resistant expansion joints. The expansion joint is applicable backer rods for expansion joints, and, more particularly, for walls of masonry, precast, and reinforced concrete expansion joints, a backer rod that controls the depth of sealants used therein relates generally to firestopping and, more particularly, to a method and apparatus for firestopping an opening in, for example, a wall, floor, or ceiling, which has items such as cables or wires passing through it. This relates to intumescent gap seals and intumescent fire protection barriers.

### FEDERALLY SPONSORED RESEARCH

None.

### SEQUENCE LISTING OR PROGRAM

None.

### BACKGROUND—FIELD OF INVENTION and PRIOR ART

As far as known, there are no other Improved Rapid Expansion Fire Stop and System for Wall Openings such as provided in this application.

Commercial building structures often incorporate fire rating requirements as a means for safe egress in case of emergencies. Often controlled by the International Building Code (IBC), commercial buildings require a good fire-rating before a building can be occupied. Examples of this would be on specifications for elevator shafts, stairwells, corridors, commercial kitchens and electrical rooms. This is often used for all fire walls or fire breaks built into the structure. In the design and construction of buildings, a variety of architecture requirements and building codes must be considered. Building structures often incorporate expansion joints to accommodate the movement of structural elements because of temperature changes or seismic activity. Local building codes in addition often require expansion joints to meet minimum requirements for fire resistance. This means that the fire barrier assembly used to close the expansion joint opening must not only be capable of accommodating movement but must in addition be capable of resisting flame penetration while limiting heat rise through the expansion joint to the level prescribed in the code. While such techniques are generally satisfactory for resisting the spread of fire and preventing the passage of smoke from one room or compartment of a structure to another, installation is time consuming and expensive. In addition, when intumescent materials are used, they must be mechanically attached to, or physically compressed into, the opening, or both, in order to pass the hose stream portion of the fire test defined in ASTM E814-02.

When the expansion joint is part of the building envelope it must also be weatherproof. External elements are also one of many factors to be addressed, For example, construction joints in various structures are often required to be sealed, ensuring a compartment within a building structure is protected from air or water transfer. If the construction is fire-resistant rated, a seal may also be required to have insulation properties and/or be fire resistant to contain a fire in the area of origin. A seal of this type prohibits the spread of the fire, for example, from the floor of origin to another floor. Although the fire could spread in any direction, in a floor seal the anticipated fire exposure is conventionally assumed from the bottom in test standards.

It is well known to use backer rods to fill spaces in joints, cracks or other openings (hereinafter “gaps”), commonly found in and between building panels such as floors, walls, etc., prior to applying a sealant. In this regard, many gaps are sufficiently deep, wide or extend through panels of several inches or more, making the use of high-cost sealants to fill the entire gap inefficient and costly. Backer rods are flexible foam rods used to fill gaps and joints in construction. Backer rods are commonly known to be used to fill the gap to within about one-half inch (½ in) or so of the surface, thus controlling the depth and amount of sealant needed, so that the sealant needs only to fill the portion of the gap from the backer rod to about the surface of the building panel(s). In these building environments, the gaps must be filled with a fire and/or smoke blocking functionality to keep fire and/or smoke from advancing upward from floor to floor. In the past standard backer rods for sealant control were developed from closed cell polyethylene foam. These standard backer rods are often extruded round rods of low-density, polyethylene (LDPE) material with a self-skinned outer covering. Upon use and prior to a sealant being applied, masonry backer rods are inserted into joints between two cured masonry sidewalls. In nominal terms, the backer rod, which has a diameter of approximately 125% of the joint width, is compressively inserted into the joint and is installed at a depth of one-half the width thereof. Depending on the width of the crack/joint in the wall, these can be installed by hand (wider joints) or by utilizing a simple rod or A straight configured tool for assistance with a smaller gap/cack where the installer's hands are too large for the small carack,

To meet architectural standards and building code requirements, the installed standard backer rod needs to exhibit several specific physical properties, The first of these is inertness so that the self-skinned, polyethylene foam structure does not react with to the sealant materials. In the past it was also believed that the sealant and the backer rod should operate independently from one another and thus, besides being inert, it was desired that the backer rod not adhere to the sealant. The backer rod also must be stable over a broad temperature range, provide low water absorption, and adequate insulative qualities.

While these fire-rated wall construction components and assemblies are also commonly used in the construction industry, the components and assemblies are aimed at preventing fire, heat, and smoke from leaving one portion of a building or room and entering another, usually through vents, joints in walls, or other openings. The components often incorporate fire-retardant materials which substantially block the path of the fire, heat, or smoke for at least some period of time. Intumescent materials work well for this purpose, since they will swell and char when exposed to flames, helping to create a barrier to the fire, heat, and/or smoke. To slow this progression of fires, Intumescent fire stop devices have been developed. Heat from fires causes the plastic, foam, and other materials to melt or burn. At the same time, the heat from the fires causes the intumescent material to expand and closing off the through hole left by the melted plastic pipe or left by the burned off insulation on the insulated pipe. The expanded intumescent material in the expansion joint or through hole in the wall or ceiling creates an insulating, fire retardant barrier that slows the spread of fires. Intumescent materials and coatings are materials that react under the influence of heat and swell to thirty-three (33) times their original thickness, producing an insulating “char” that protects the substrate to which the coating is applied from the effects of fire. With this background, the applicant developed his unique idea for sealing expansion joints in an effective manner to address the possibility of fire.

### PROBLEMS SOLVED

Many problems and irritations are solved with the advent of the Improved Rapid Expansion Fire Stop and System for Wall Openings. The advantages described below help the contractors and builders to achieve a fire stop and the resistance to flames and heat that is required to meet or exceed building codes. Other advantages include: simplifying installation and eliminating components used with a standard mineral wool installation for expansion joints of cementitious walls; reduces labor of installation; and meets or exceed NFPA 285 fire stop test for commercial walls. Also, this avoids environmental and safety concerns of handling and installing mineral wool—gloves, clothing and breathing support.

### PRIOR ART

A novelty search was completed for an Improved Rapid Expansion Fire Stop and System for Wall Openings. It revealed the following:
A. EP0486299A1 by McCurdy et al., issued in 1992 for an Intumescent fire stop device. This is a fire stop device having a collar, the device is easy to install and effectively and efficiently channels heat to an intumescent material so that the intumescent material expands quickly and uniformly. An inner surface of the collar has a plurality of heat conducting tabs that extend outwardly and secure the intumescent material to the collar. The heat conducting tabs extend into the intumescent material and thereby effectively channel heat from a fire into the interior regions of the intumescent material so that the intumescent material expands quickly and uniformly.
B. EP3643364A1 by Ahlers et al., issued in 2020 for a Fire protection element for sealing holes in components. This relates to a fire protection element with a laminate for sealing through openings in components, such as building components, through which lines are led. Furthermore, the present invention relates to a method for producing the fire protection element according to the invention and the use of the fire protection element for sealing through openings and/or joints in components against fire and flue gases.
C. GB2108614A by Ward issued in 1985 for a Fire-seal for pipe or duct extending through wall, floor or ceiling. Shown is a fire-seal for a pipe or duct extending through a wall, floor or ceiling comprises a sleeve having an outer cylindrical casing, a perforate cylinder of material of high thermal conductivity contained within the cylindrical casing, and a cylindrical layer of intumescent material on the inner surface of the outer cylindrical casing and within which the perforate cylinder is embedded. The perforate cylinder is preferably of wire mesh and adjacent the inner surface of the layer of intumescent material,
D. JP2017210378A by Araki et al., issued in 2017 for a Composition and non-flammable material. Here is shown a composition which imparts non-flammability without impairing heat insulating property. SOLUTION: A composition contains cement, a substance which has a specific area of 4500-12000 cm/g and contains at least free lime, anhydrous gypsum and hauyne, inorganic powder having a hollow structure having an average particle diameter of 20-60 μm, and waste glass foam body powder having an average particle diameter of 20-130 μm.
E. NL2025589B1 by Frank et al., issued in 2020 for a Firestop collar. This is a firestop collar that is arranged around a duct at a passage through a partition. The firestop collar comprises an outer casing of sheet metal and an inner lining of intumescent material. The outer casing has a first end portion and a second end portion adapted to be mutually connected so as to maintain the firestop collar in a closed position around a duct. A locking member is formed integrally with the casing at the first end portion and a catch member is integrally formed with the casing at the second end portion. The catch member comprises a sheet metal strip extending spaced apart from the outer surface of the casing to define a slot between the catch member and the outer surface of the casing.
F. U.S. Pat. No. 4,442,157 by Marx et al., issued in 1984 for a Fireproofing composition and door rabbet coated therewith. This is a Heat-foamable fireproofing compositions contain thermosetting phenolic resins, thermally decomposable organic nitrogen compounds, eg. dicyandiamide, an ammonium salt and a carbohydrate or polyhydric alcohol, and on decomposition form a stiff carbonaceous foam
G. U.S. Pat. No. 4,513,173 by Merry issued in 1985 for an Intumescent fire protective sheaths. Intumescent fire protective sheaths useful for the protection of electric cables and conduits from open flame damage and methods for making such sheaths. The sheath comprises sheets of substantially inorganic intumescent material capable of arrangement around the cable or the conduit to form a protective layer.
H. U.S. Pat. No. 4,888,925 by Harbeke issued in 1989 for a Fire-retardant fluid coupling assembly and method. A pipe coupling assembly and method of manufacturing the same involves the use of a pipe coupling with an intumescent collar and a metallic band wrapped thereabout at one end thereof. The metallic band has overlapping ends which are held together by elongated fasteners passing through overlapping portions and into the intumescent wrap. The pipe coupling assembly including a tubularly-shaped main body, an intumescent collar, and a metallic band are assembled as a unit in a factory to be later placed in a concrete form to have concrete poured thereabout. The second end edge of the intumescent collar is abutted firmly against a protective flange which is molded as part of the pipe coupling and which covers the whole second end edge of the intumescent collar.
I. U.S. Pat. No. 5,103,609 by Thoreson et al., issued in 1992 for an Intumescable fire stop device. An intumescable fire stop device that is easy to install and effectively and efficiency channels heat to an intumescent material so that the intumescent material expands quickly and uniformly includes a collar. An inner surface of the collar has a plurality of heat conducting tabs that extend outwardly and secure the intumescent material to the collar. The heat conducting tabs extend into the intumescent material and thereby effectively channel heat from a fire into the interior regions of the intumescent material so that the intumescent material expands quickly and uniformly. The collar further includes a first interlocking end having a plurality of spaced openings. The spaced openings are configured to receive spaced fingers on a second interlocking end of the collar. The inter-engagement of the fingers and openings allows the collar to be firmly secured about a section of a pipe. The collar has a plurality of releasably secured Z-shaped mounting clips, The mounting clips are used to secure the collar to a firm, structural surface such as a wall or ceiling having an opening through which the pipe passes.
J. U.S. Pat. No. 5,887, 396 by Thoreson issued in 1999 for an Intumescable fire stop device having quick fasteners. An intumescable fire stop device and method of installing the same including a collar and a fastening device. The collar includes intumescable material supported by a jacket. The fastening device includes an axial shaft portion, a radial shank portion and a means to attach the fastening device to the collar, The radial shank portion is placed through an opening in a wall or other rigid surface through which a pipe or other member extends and between the wall and the pipe. The radial shank portion is then extended on the far side of the wall to engage the far side of the wall and firmly secure the collar to the near side of the wall,
K. U.S. Pat. No. 8,444,790 by Tong issued in 2013 for a multi-layer intumescent fire protection barrier with adhesive surface. An intumescent fire protection barrier in the form of an adhesive sheet or continuous roll of tape. The barrier comprises laminated layers of an intumescent material, a reinforcing matrix, a pressure sensitive adhesive and a release liner. The intumescent material is adhesively applied to a structural steel substrate and expands by at least 10 times its original thickness during a fire to provide fire protection to the substrate. Multiple layers of the fire protection barrier may be installed on top of one another. This application method dramatically reduces installation time as compared with sprayed on fire protection coatings.
L. U.S. Pat. No. 8,578,672 by Mattox et al., issued in 2013 for an Intumescent backer rod. A backer rod adapted for forming a fire-resistant seal within a construction joint. The backer rod may include an elongated tube defining a total assembly volume and a hollow interior, and a core disposed within the hollow interior. The tube is formed of a combustible foam plastic which disintegrates when exposed to fire. The core material is expandable when exposed to fire, such that the core has an intumescent expansion factor sufficient to expand to a volume beyond the total assembly volume. The backer rod may be press-fit into a void between two surfaces to a depth. A sealant layer may be formed within the void. When exposed to fire on a side opposite the sealant layer, the external shell disintegrates, the core expands within the void in a direction away from the sealant layer, and a fire-resistant barrier is formed within the void between the surfaces.
M. U.S. Pat. No. 10,704,751 by Luo et al., issued in 2020 for a Downlight Firestop. An intumescent firestop element is supported within a light can by fire sensitive supports each having a base fabricated of a meltable or flammable material and a supporting element fabricated of metal and supported by the base, with the base joined to the light can. In response to a fire, the fire sensitive supports cease to support the firestop element which drops to a deployed position in the light can until arrested by a limiter.
N. U.S. Pat. No. 11,060,283 by Pilz et al., issued in 2021 for a Fire-rated wall construction product. Fire-rated wall construction components and wall systems for use in building construction, Embodiments can include tracks for holding studs which incorporate various geometries capable of receiving fire-retardant material, including but not limited to intumescent material. The fire-retardant material can be attached to compressible backer rods inserted within deflection gaps in the wall systems such that the fire-retardant material expands and seals gaps and/or areas between the tracks and wall components such as ceilings, floors, and drywall. Various assemblies and methods can be used to cover the deflection gap.
O. U.S. Pat. No. 11,555,306 by Pullinger et al., issued in 2023 for a Fire-Stopping Product. The invention provides a fire-stopping product, an insulated building façade comprising a fire-stopping product, and a method of making a fire-stopping product. The fire-stopping product comprises a resilient, porous material at least partially impregnated with an intumescent agent and held in compression by a releasable restraint. When exposed to hot gases from a fire, the restraint yields to release the resilient, porous material in an initial expansion, thereby exposing the intumescent agent to the hot gases and allowing rapid intumescence to occur. When implemented in a ventilated building façade, the fire-stopping product is able to close an air gap in a short amount of time.
P. US2003/0175497 by Kobe et al., applied for in 2003 for a Flame-retardant foam, articles including same and methods for the manufacture thereof. A flame retardant article foamed substrate is described, the article comprising a polymeric foam material comprising a polymer, antimony-free fire retardant and a plurality of microspheres, the foam material having an outer surface; and an adhesive layer on the outer surface, the adhesive layer is preferably formulated without fire retardant. The polymeric foam material is selected from the group consisting of elastomers, rubbers, thermoplastic elastomers, rubber based and acrylic adhesives, polyolefin polymers, acrylate polymers and methacrylate polymers, acrylate and methacrylate copolymers, and combinations thereof. The adhesive layer may comprise a pressure sensitive adhesive, a heat-activated adhesive, or the like. Viscoelastic or elastic microfibers may be incorporated into the foam material, into the adhesive layer, or both to impart stretch release properties to the finished article.
Q. US2011/0314755 by Langille et al., applied for in 2011 for an Intumescent Fire Door Edge System. An intumescent strip includes a first material layer and an opposing second material layer. A third material layer, formed from an intumescent material, is positioned between the first and second layers. The intumescent material includes a combination of intumescent particles suspended within a thermoplastic material. The intumescent particles have an activation temperature and are expandable when exposed to temperatures above the activation temperature. The thermoplastic material has a melting temperature that is lower than the activation temperature.
R. US2019/0360199 by Pilz et al., submitted in 2019 for a Fire Rated Wall Construction Product. Fire-rated wall construction components and wall systems for use in building construction. Embodiments can include tracks for holding studs which incorporate various geometries capable of receiving fire-retardant material, including but not limited to intumescent material. The fire-retardant material can be attached to compressible backer rods inserted within deflection gaps in the wall systems such that the fire-retardant material expands and seals gaps and/or areas between the tracks and wall components such as ceilings, floors, and drywall. Various assemblies and methods can be used to cover the deflection gap.
S. WO/2005000975 by Green et al., submitted in 2005 for Intumescent Coating Compositions. A liquid intumescent coating composition comprising a resin system. The resin system comprises at least one polymeric component, one or more ethylenic ally unsaturated monomeric components and at least one intumescent ingredient. The coating composition is curable to a solid state in a free-radical polymerization reaction.
T. WO/2016/186486 by Frank et al., applied for in 2016 for an Adjustable Fire Stop Collar. A stop sleeve for arrangement in a passage for a conduit or cable or the like in a partition such as a wall or a ceiling comprises an outer casing and intumescent material arranged on a radially inner side of the outer casing, The casing comprises at least two interconnected coaxial casing portions which have at least overlapping end portions and which are slidable with respect to each other to extend the length of the sleeve to adjust the length to a thickness of the partition. At least one tangentially extending strip of intumescent material is arranged on the inner side of each of the casing portions that are axially most outwardly located.
U. US Patent Application US 2012/0023846A1 owned by Mattox et al. sent in 2012 for an INTUMESCENT BACKER ROD. A backer rod adapted for forming a fire-resistant seal within a construction joint. The backer rod may include an elongated tube defining a total assembly volume and a hollow interior, and a core disposed within the hollow interior. The tube is formed of a combustible foam plastic which disintegrates when exposed to fire, The core material is expandable when exposed to fire, such that the core has an intumescent expansion factor sufficient to expand to a volume beyond the total assembly volume. The backer rod may be press-fit into a void between two surfaces to a depth. A sealant layer may be formed within the void. When exposed to fire on a side opposite the sealant layer, the external shell disintegrates, the core expands within the void in a direction away from the sealant layer, and a fire-resistant barrier is formed within the void between the surfaces.
V. U.S. Pat. No. 8,318,304 B2 issued to Valenziano in 2004 for an INTUMESCENT ROD. An intumescent rod comprising an intumescent component formed of an intumescent material and a polymer matrix. The intumescent rod may include a second component forming a covering, core or layer adjacent the intumescent component. A method for manufacturing an intumescent rod including molding or extrusion of at least one of an intumescent component and an optional second component.
W. U.S. Pat. No. 4,866,898 issued to LaRoche et al. in 1989 for a FIRE-RESISTANT EXPANSION JOINT. An expansion joint having a weather resistant cover and a fire barrier. The cover is a bellows attached to the upper surface of the adjacent joint structure by mounting flanges, and the barrier is a fire resistant inorganic fabric sheet mounted in the joint. The fabric supports resilient fire resistant inorganic fibrous insulation and is connected to the adjacent joint structure by mounting flanges. The flanges may be in the form of a bifurcated clamp, and one of the fabric-engaging clamp faces may be crimped and pierced to better grip the fabric.
X. U.S. Pat. No. 6,997,640 B1 by Hohmann, Jr issued in 2006 for a BACKER ROD FOR EXPANSION JOINTS. A backer rod adapted for insertion into a construction joint having a polymeric foam body of closed-cell construction and a foraminous skin with both open and closed cells. The backer rod, when compressively inserted into a construction joint, is impervious to hot and cold sealants alike and maintains the seal integrity during the extremes of expansion and contraction. The backer rod is usable over the temperature range of −70 to 450 degrees Fahrenheit. The backer rod hereof is a continuously extruded closed-cell foam body that is degassed by a secondary extrusion. The skin portion is formed by heat treating the exterior of the polymeric foam body so as to create micro-perforations therein.

As can be observed, none of the prior art has anticipated or caused one skilled in the art of backer rod for sealing walls, doors and window openings to see this unique insulation and fire-resistant device as obvious to one skilled in the industry. The Improved Rapid Expansion Fire Stop and System for Wall Openings provides an answer to a contractor with expansion joints to avoid all the problems mentioned above as well as the advantages listed below in an efficient manner.

### SUMMARY OF THE INVENTION

This invention provides a fire-rated system designed for construction joints in wall/floor systems. It is comprised of open/closed/bi-celled backer rod, impregnated foam whether it is acrylic, wax or asphaltic. Along the inside of two half-moon shaped types of the foam listed above, is an intumescent strip that when exposed to high temperatures expands up to 33 times its size, preventing the passage of flames, hot gasses, and smoke.

The preferred embodiment of the Improved Rapid Expansion Fire Stop and System for Wall Openings is comprising: (a) a backer rod comprised of a durable foam material in a pre-determined size with a predetermined cross-sectional configuration, the backer rod having an aperture/slot/ void in foam; and (b) an intumescent strip with characteristics of expanding thirty-three (33) times its size/volume when exposed to high heat or flame wherein when a wall made of cementitious material has been constructed and has an opening or crack such as an expansion joint, the improved rapid expansion fire stop and system serves as a fire stop to fire, smoke and heat by expanding and fully sealing the wall opening and crack from any intrusion pr passage of the heat, smoke or flame through the opening.

### OBJECTS AND ADVANTAGES

There are several objects and advantages of the device that is an Improved Rapid Expansion Fire Stop and System for Wall Openings. These various advantages and benefits that help the construction industry include:

| Item | Advantages |
|---|---|
| 1 | Saves cost by simplifying installation and eliminating |
| | components in a standard mineral wool installation |
| | for expansion joints of cementitious walls |
| 2 | Reduces labor of installation |
| 3 | Meets or exceed NFPA 285 fire stop test for |
| | commercial walls |
| 4 | Avoids environmental and safety concerns of handling and |
| | installing mineral wool - gloves, clothing and breathing support |
| 5 | Can easily dispose of scrap into landfills |
| 6 | Multiple cross-sections and configurations |
| 7 | Reduces inventory at job site |
| 8 | Can be prepared off-site and then cut to length to fit at job site |

Finally, other advantages and additional features of the present Improved Rapid Expansion Fire Stop and System for Wall Openings will be more apparent from the accompanying drawings and from the full description of the device. For one skilled in the art of constructing buildings and walls with expansion joints that need fireproofing, it is readily understood that the features shown in the examples with this product can be adapted to other types of building systems and the like.

### DESCRIPTION OF THE DRAWINGS—FIGURES

The accompanying drawings, which are incorporated in and constitute a part of this specification, illustrate an embodiment of the Improved Rapid Expansion Fire Stop and System for Wall Openings. The drawings together with the summary description given above and a detailed description given below help to explain the principles of the Improved Rapid Expansion Fire Stop and System for Wall Openings. It is understood, however, that this improved expanding rapid expansion fire stop and system is not limited to only the precise arrangements and instrumentalities shown.

FIGS. 1A through 1D are sketches of a device that is an improved rapid expansion fire stop and system for Wall Openings.

FIGS. 2A and 2B are sketches of a prototype of an improved rapid expansion fire stop and system for Wall Openings.

FIGS. 3A through 3D are design sketches of the improved rapid expansion fire stop and system for Wall Openings.

FIGS. 4A through 4F are sketches of a manner to fill wall openings with an extended portion of intumescent strip which forms a “U” shape as it expands and fills the void for wall openings.

FIGS. 5A through 5D are sketches of a manner to fill wall openings with a wraparound portion of intumescent strip which forms a “U” shape as it expands and fills the void for wall openings.

FIGS. 6A through 6D are sketches of a typical manner to fill wall openings and of the improved expanding rapid expansion fire stop for wall openings 120.

FIGS. 7A through 7F are sketches of Prior Art in the field of filling the wall openings 120 with filler and/or fire stops.

### DESCRIPTION OF THE DRAWINGS—REFERENCE NUMERALS

The following list refers to the drawings:

TABLE B
Reference numbers -

| Item | Description |
|---|---|
| 30 | a device and system 30 that is an improved rapid |
| | expansion fire stop and system for wall openings |
| | 120 |
| 30A | a fold an extended strip device and system 30A |
| | that is an improved rapid expansion fire stop and |
| | system 30 for wall openings 120 |
| 30B | a wraparound device and system 30B that is an |
| | improved rapid expansion fire stop and system 30 |
| | for wall openings 120 |
| 31 | a protype device 31 of a device and its system 30 |
| | that is an improved rapid expansion fire stop and |
| | system 120 |
| 35 | after exposure 105 to high heat/flame 110 or the |
| | like an improved expanding rapid expansion fire |
| | stop 33 for wall openings 120 |
| 40 | foam of backer rod 40 |
| 41 | aperture/slot/void 41 in foam 40 |
| 50 | intumescent strip 50 expands thirty-three (33) |
| | times when heated to flame temperature and is |
| | fire-proof material to create a fire stop |
| 50A | extended portion of intumescent strip 50A which |
| | forms a “U” shape as it expands and fills the |
| | void |
| 50B | a wraparound portion of intumescent strip 50B |
| | which forms a “U” shape as it expands and fills |
| | the void |
| 60 | architectural sealant 60 of various materials - |
| | water based Latex, Acrylic, Butyl, Polysulfide, |
| | Silicone, Polyisobutylenes, Polyurethane, and the |
| | like |
| 70 | mineral wool 70 for insulation and fill, mineral |
| | wool is a superior insulation product. It has a |
| | higher R-value per inch compared to fiberglass, |
| | about a 22-37% higher R-value. It contains 70% |
| | recycled material, making it a greener product |
| | than fiberglass |
| 100 | common means 100 to insulate cracks 128 with |
| | mineral wool 70 |
| 103 | the resultant wall 103 after exposure 105 to |
| | flame or high heat 103 the common means 100 to |
| | insulate cracks 128 with mineral wool 70 |
| 105 | exposure 105 to flame or high heat |
| 107 | fire 107 |
| 110 | flame and smoke 110 of a fire 107 |
| 120 | wall opening 120 or joint 120A with cracks/ |
| | apertures 128 where flame and smoke 110 can |
| | infiltrate a wall system 125 |
| 125 | wall system 125 |
| 128 | cracks/apertures 128 |
| 300 | cross-section 300 of an improved expanding rapid |
| | expansion fire stop 30 for wall openings 120 of a |
| | wall system 125 |
| 301 | example cross-section such as a triangle 301 |
| 302 | example cross-section such as a circle 302 |
| 303 | example cross-section such as a rectangle 303 |
| 304 | example cross-section such as a square 304 |
| 305 | example cross-section such as a pentagon 305 |
| 306 | example cross-section such as a hexagon 306 |
| 307 | example cross-section such as an ellipse 307 |
| 308 | example cross-section such as an octagon 308 |
| 700 | Prior Art 700 US Patent US 8, 318, 304 B2 issued to |
| | Valenziano in 2004 for an INTUMESCENT ROD |
| 710 | Prior Art 710 US Patent US 4, 866,898 issued to |
| | LaRoche et al. in 1989 for a Fire-resistant |
| | Expansion Joint |
| 720 | Prior Art 720 US Patent Application US |
| | 2012/0023846A1 owned by Mattox et al. sent in |
| | 2012 for an Intumescent Backer Rod |
| 730 | 8444790 Prior Art 730 US Patent US 8, 444, 790 B2 |
| | issued to Tong in 2013 for a Multi-layer |
| | Intumescent Fire Protection Barrier with Multi- |
| | Layer with Adhesive Surface |
| 740 | Prior Art 740 US Patent US 11, 555, 306 B2 issued |
| | to Pullinger et al. in 2023 for a Fire-Stopping |
| | Product |
| 750 | Prior Art 750 US 8,578, 672 B2 issued to Mattox |
| | et al. in 2013 for an Intumescent Backer Rod |

### DETAILED DESCRIPTION OF PREFERRED EMBODIMENT

The present invention relates to an Improved Rapid Expansion Fire Stop and System for Wall Openings. This application is directed toward fire-rated wall construction components for use in building construction. It relates generally to expansion joints and more particularly, it relates to fire resistant expansion joints. The expansion joint is applicable backer rods for expansion joints, and, more particularly, for walls of masonry, precast, and reinforced concrete expansion joints, a backer rod that controls the depth of sealants used therein relates generally to firestopping and, more particularly, to a method and apparatus for firestopping an opening in, for example, a wall, floor, or ceiling, which has items such as cables or wires passing through it. This relates to intumescent gap seals and intumescent fire protection barriers.

The advantages for the device and its system 30 that is an improved rapid expansion fire stop and system are:
A. Saves cost by simplifying installation and eliminating components in a standard mineral wool installation for expansion joints of cementitious walls
B. Reduces labor of installation
C. Meets or exceed NFPA 285 fire stop test for commercial walls
D. Avoids environmental and safety concerns of handling and installing mineral wool—gloves, clothing and breathing support
E. Can easily dispose of scrap into landfills
F. Multiple cross-sections and configurations
G. Reduces inventory at job site
H. Can be prepared off-site and then cut to length to fit at job site

The preferred embodiment of the improved rapid expansion fire stop device and system 30 for wall openings 120 is comprising: (a) a backer rod 40 comprised of a durable foam material in a pre-determined size with a predetermined cross-sectional configuration, the backer rod having an aperture/slot/ void 41 in foam 40; and (b) an intumescent strip 50 with characteristics of expanding thirty-three (33) times its size/volume when exposed to high heat or flame wherein when a wall 125 made of cementitious material has been constructed and has an opening or crack 128 such as an expansion joint, the improved expanding rapid expansion fire stop 30 serves as a fire stop to fire, smoke and heat by expanding and fully sealing the wall opening 120 and crack 128 from any intrusion pr passage of the heat, smoke or flame through the opening 120.

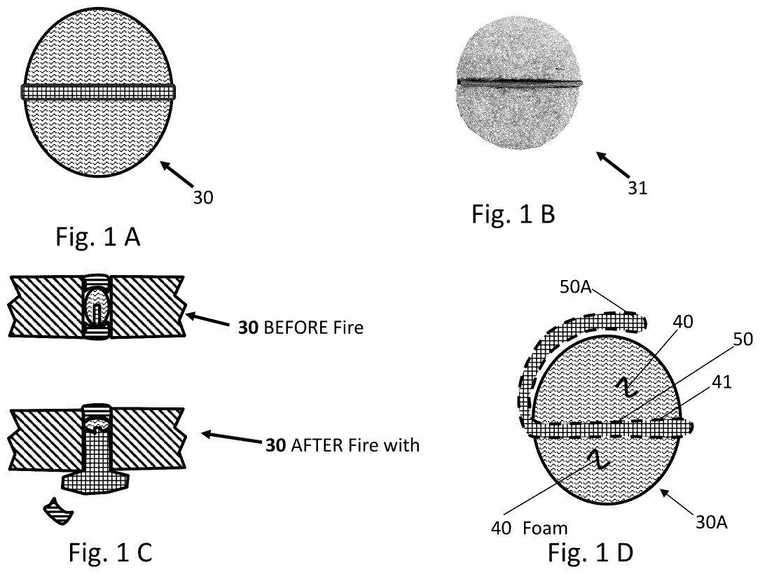

There is shown in FIGS. 1-7 a complete description and operative embodiment of the improved rapid expansion fire stop system 30 for wall openings 120. In the drawings and illustrations, one notes well that FIGS. 1-7 demonstrate the general configuration and use of this product. The operation and use section, below, describes how it is installed with the patient. The accompanying drawings, which are incorporated in and constitute a part of this specification, illustrate an embodiment of the improved expanding rapid expansion fire stop 30 for wall openings 120. The drawings together with the summary description given above and a detailed description given below serve to explain the principles of the improved rapid expansion fire stop and system 30 for wall openings 120 for use by contractors and wall installers to seal the edges of wall openings. It is understood, however, that the device 30 is not limited to only the precise arrangements and instrumentalities shown. Other examples for using the device and their uses are still understood by one skilled in the art of sealing walls and insulating cracks of walls to be within the scope and spirit shown here.

FIGS. 1A through 1D are sketches of a device that is an improved rapid expansion fire stop and system 30 for wall openings. Viewed in these drawings are a device that is an improved expanding rapid expansion fire stop 30 for wall openings 120; a fold and extended strip device and system 30A that is an improved rapid expansion fire stop and system 30 for wall openings 120 and a protype device 31 of an improved expanding rapid expansion fire stop 30 for wall openings 120.

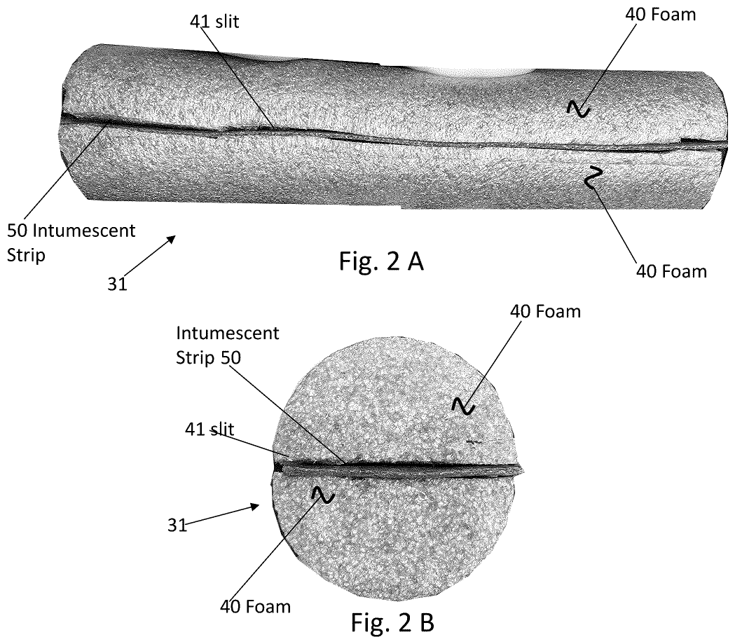

FIGS. 2A and 2B are sketches of a prototype 31 of an improved rapid expansion fire stop and system 30 for wall openings 120. Described here are a protype device 31 of an improved expanding rapid expansion fire stop 30 for wall openings 120; a foam of backer rod 40; an aperture/slot/void 41 in foam 40; and an intumescent strip 50 expands thirty-three (33) times when heated to flame temperature and is fire-proof material to create a fire stop.

Fire-rated wall construction components and assemblies are also commonly used in the construction industry. These components and assemblies are aimed at preventing fire, heat, and smoke from leaving one portion of a building or room and entering another, usually through vents, joints in walls, or other openings. The components often incorporate fire-retardant materials which substantially block the path of the fire, heat, or smoke for at least some period of time. Intumescent materials work well for this purpose, since they swell and char when exposed to flames, thus helping to create a barrier to the fire, heat, and/or smoke. The space created in the seam of the wall allows for independent expansion and movement of the wall when no fire is present. When temperatures rise, the intumescent material expands rapidly. This expansion creates a barrier which fills the seam of the wall and substantially inhibits or at least substantially prevents fire, heat, and smoke from moving through the joint of the wall for at least some period of time. Intumescent coating compositions are commonly used to protect structural components in buildings against the effects of fire conditions. They contain a resin system “pigmented” with various intumescent ingredients that under the influence of heat, react together to produce an insulating foam or “char”, having low thermal conductivity, which has a volume many times that of the original coating. This char greatly reduces the rate of heating experienced by the wall, thereby allowing additional time for safe evacuation.

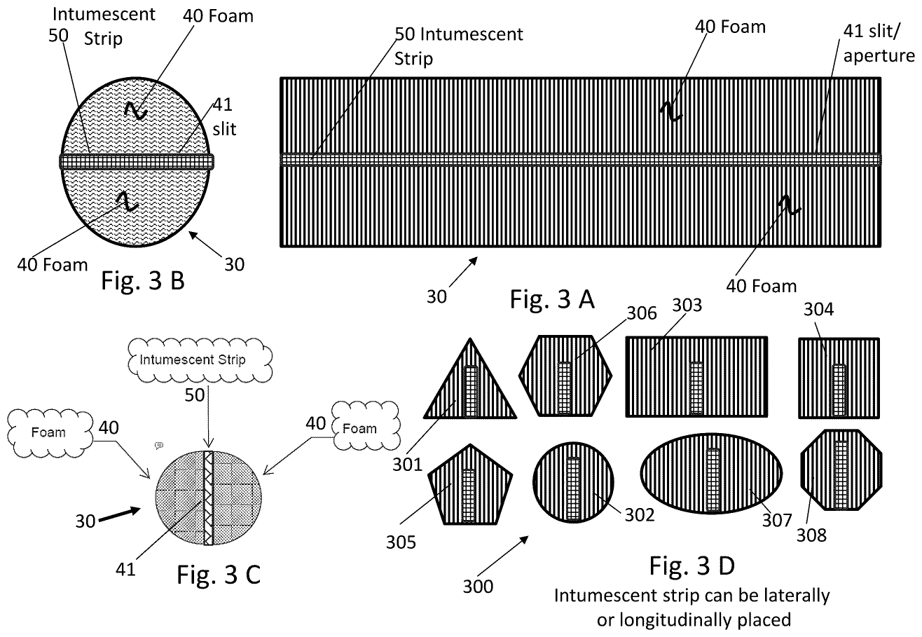

FIGS. 3A through 3D are design sketches of the improved rapid expansion fire stop and system 30 for wall openings 120. Provided in these drawings are: a device that is an improved expanding rapid expansion fire stop 30 for wall openings 120; a foam of backer rod 40; an aperture/slot/void 41 in foam 40; and an intumescent strip 50 expands thirty-three (33) times when heated to flame temperature and is fire-proof material to create a fire stop; a group of examples of cross-section 300 of an improved expanding rapid expansion fire stop 30 for wall openings 120 of a wall system 125 for example cross-section such as a triangle 301; example cross-section such as a circle 302; example cross-section such as a rectangle 303; example cross-section such as a square 304; example cross-section such as a pentagon 305; example cross-section such as a hexagon 306; example cross-section such as an ellipse 307; example cross-section such as an octagon 308. These strips 30 are inserted by hand with a wide opening 120 or with a straight insertion tool to assist for tight (1 inch and less) openings 120.

NFPA 285 is the “Standard Fire Test Method for Evaluation of Fire Propagation Characteristics of Exterior Wall Assemblies Containing Combustible Components.” Despite the lengthy name, the goal of the test is quite simple-to understand how fire will spread on an exterior wall. NFPA 285 is a commercial wall assembly test that is designed to determine if an exterior wall assembly that contains combustible components meets an acceptable level of fire performance for use in non-combustible construction Building Types. In most buildings of Type I, II, III and IV construction, foam plastic triggers NFPA 285 testing (with limited exceptions). Other triggers include combustible claddings and combustible weather resistive barriers when the building is over 40 feet tall. Generally, the acceptance criteria involves the following: A. Flame propagation on the exterior face of the wall assembly—
1. Vertical flame spread of less than 10 feet above the window opening in the test
2. Lateral flame spread of less than 5 feet from the centerline of the window opening
3. Temperature less than 1000 F at a point 10 feet above the window opening.

### B. Flame Propagation Through Combustible Components and Insulation

Depending on the materials used in the exterior wall assembly, there are various temperature requirements that must be met. These include:
1. Limitations on temperature within exterior wall panels containing combustible components.
2. Limitations on temperature within the air cavity between exterior wall panels and the wall itself.

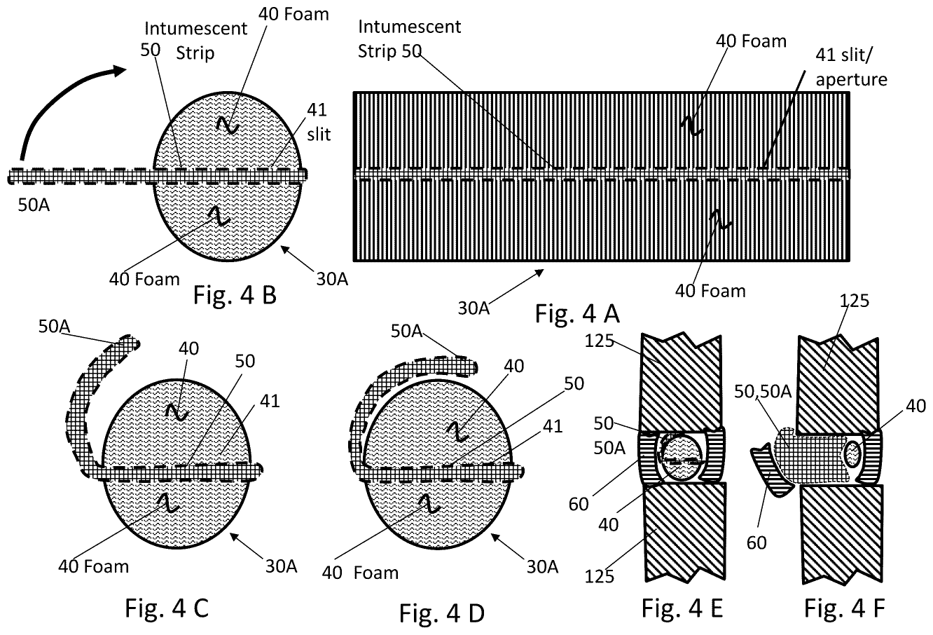

FIGS. 4A through 4F are sketches of a manner to fill

wall openings with an extended portion 50A of intumescent strip 50 which forms a “U” shape as it expands and fills the void for wall openings. Provided in these drawings are a device a fold and extended strip device and system 30A that is an improved rapid expansion fire stop and system 30 for wall openings 120; a foam of backer rod 40; an aperture/slot/void 41 in foam 40; and an intumescent strip 50 expands thirty-three (33) times when heated to flame temperature and is fire-proof material to create a fire stop; an extended portion of intumescent strip 50A which forms a “U” shape as it expands and fills the void; an architectural sealant 60 of various materials—water based Latex, Acrylic, Butyl, Polysulfide, Silicone, Poly-isobutylenes, Polyurethane, and the like; a wall system 125; and a wall opening 120 or joint 120A with cracks/apertures 128 where flame and smoke 110 can attempt to infiltrate a wall system 125. These strips 30A are inserted by hand with a wide opening 120 or with a straight insertion tool to assist for tight (1 inch and less) openings 120.

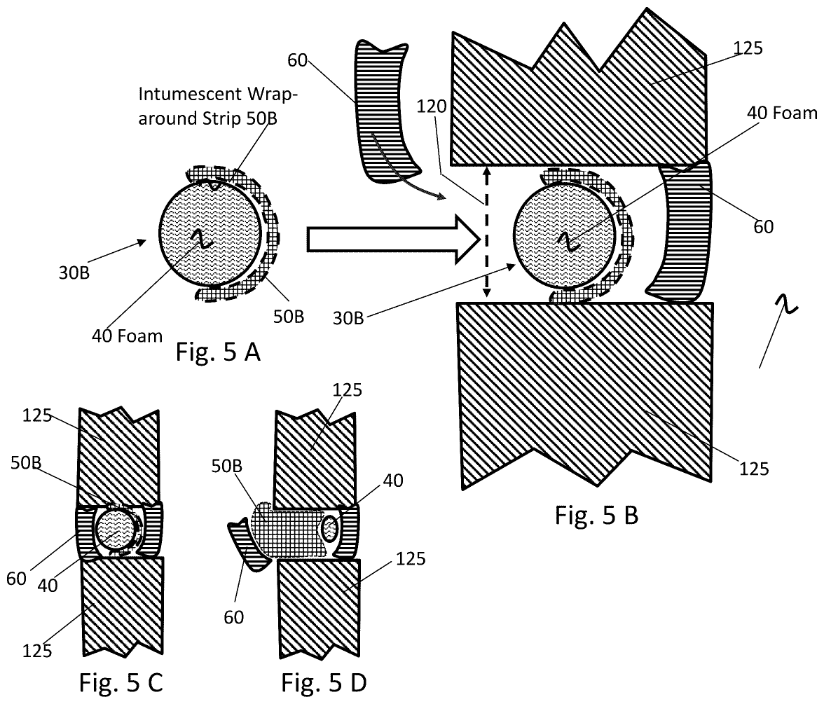

FIGS. 5A through 5D are sketches of a manner to fill wall openings with a wraparound device 50B and system 30B that is an improved rapid expansion fire stop and system 30 for wall openings 120. Portrayed are the wraparound system 30B; a foam of backer rod 40; an aperture/slot/void 41 in foam 40; a wraparound portion of intumescent strip 50B which forms a “U” shape as it expands and fills the void (the wraparound intumescent component 50B expands thirty-three (33) times when heated to flame temperature and is fire-proof material to create a fire stop); an architectural sealant 60 of various materials—water based Latex, Acrylic, Butyl, Polysulfide, Silicone, Poly-isobutylenes, Polyurethane, and the like; a wall system 125; and a wall opening 120 or joint 120A with cracks/apertures 128 where flame and smoke 110 can try to infiltrate a wall system 125. These strips 30B are inserted by hand with a wide opening 120 or with a straight insertion tool to assist for tight (1 inch and less) openings 120.

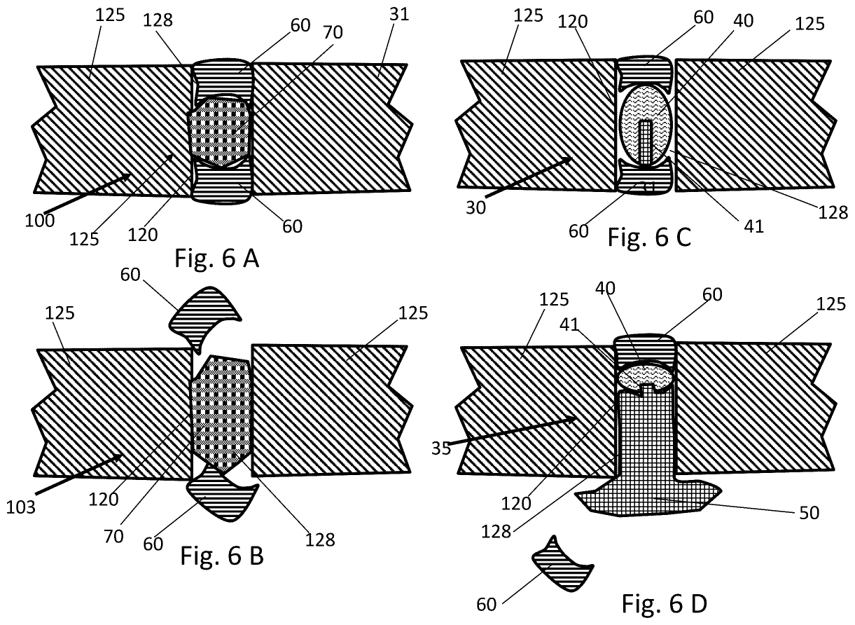

FIGS. 6A through 6D are sketches of a typical manner to fill wall openings and of the improved expanding rapid expansion fire stop 30 for wall openings 120. These sketches are described in the Operation Section, below.

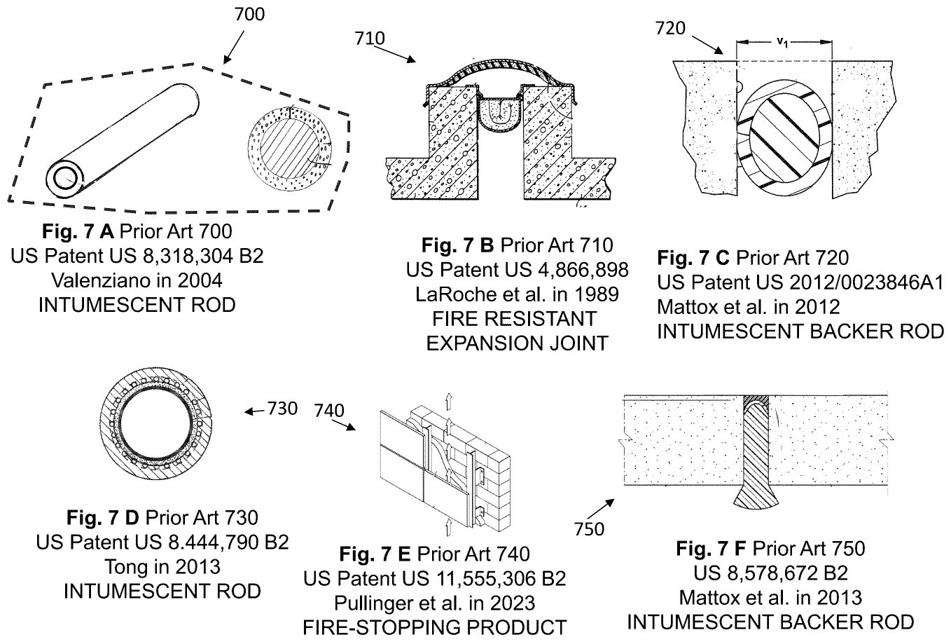

FIGS. 7A through 7F are sketches of Prior Art in the field of insulating and filling wall cracks and openings 120. These include: Prior Art 700 U.S. Pat. No. 8,318,304 B2 issued to Valenziano in 2004 for an Intumescent Rod; Prior Art 710 U.S. Pat. No. 4,866,898 issued to LaRoche et al. in 1989 for a Fire-resistant Expansion Joint; Prior Art 720 US Patent Application US 2012/0023846A1 owned by Mattox et al. sent in 2012 for an Intumescent Backer Rod; Prior Art 730 U.S. Pat. No. 8,444,790 B2 issued to Tong in 2013 for a Multi-layered Intumescent Fire Protection Barrier with Multi-Layer with Adhesive Surface; Prior Art 740 U.S. Pat. No. 11,555,306 B2 issued to Pullinger et al. in 2023 for a Fire-Stopping Product; and Prior Art 750 U.S. Pat. No. 8,578,672 B2 issued to Mattox et al. in 2013 for an Intumescent Backer Rod. As can be seen, the improved rapid expansion fire stop and system 30 for wall openings 120 for use by contractors is a unique medical device with the advantages shown above.

The materials and components shown for the improved rapid expansion fire stop and system 30 for wall openings 120 include fire and abrasion resistant materials. Intumescent components 50, 50A, 50B as a strip or sheet material is a type of material that contains a resin system. The system is “pigmented” with various intumescent ingredients that under the influence of heat, react together to produce an insulating foam or “char”, having low thermal conductivity, which has a volume many times that of the original coating. This char greatly reduces the rate of heating experienced by the wall, thereby allowing additional time for safe evacuation. There are a number of materials that exhibit intumescent behavior, but only three types are currently used in seals for fire resisting assemblies: a) Hydrated sodium silicate b) Intercalated graphite. c) Ammonium phosphate. The backer rod materials (foam) come in three main types, closed cell, open cell, and a hybrid that has closed outer cells but open interior cells. Each one of these types of backer rod has its own niche that it thrives in. The base material for the backer rod is a normally a polypropylene/polyolefin based foam.

The details mentioned here are exemplary and not limiting. Other specific components and manners specific to describing an improved rapid expansion fire stop and system 30 for wall openings 120 can be added as a person having ordinary skill in the field of insulation and crack filling for walls and the like and related devices.

### OPERATION OF THE PREFERRED EMBODIMENT

The preferred embodiment of the improved rapid expansion fire stop and system 30 for wall openings 120 is an improved expanding rapid expansion fire stop device 30 for wall openings 120 comprising: (a) a backer rod 40 comprised of a durable foam material in a pre-determined size with a predetermined cross-sectional configuration, the backer rod having an aperture/slot/void 41 in foam 40; and (b) an intumescent strip 50 with characteristics of expanding thirty-three (33) times its size/volume when exposed to high heat or flame wherein when a wall 125 made of cementitious material has been constructed and has an opening or crack 128 such as an expansion joint, the improved expanding rapid expansion fire stop 30 serves as a fire stop to fire, smoke and heat by expanding and fully sealing the wall opening 120 and crack 128 from any intrusion pr passage of the heat, smoke or flame through the opening 120.

FIGS. 6A through 6D are sketches of a typical manner to fill wall openings and of the improved rapid expansion fire stop and system 30 for wall openings 120. Portrayed in these drawings are the following: a device that is an improved rapid expansion fire stop and system 30 for wall openings 120; foam of backer rod 40; aperture/slot/void 41 in foam 40; intumescent strip 50 expands thirty-three (33) times when heated to flame temperature and is fire-proof material to create a fire stop; architectural sealant 60 of various materials—water based Latex, Acrylic, Butyl, Polysulfide, Silicone, Polyisobutylenes, Polyurethane, and the like; mineral wool 70 for insulation and fill, mineral wool is a superior insulation product. It has a higher R-value per inch compared to fiberglass, about a 22-37% higher R-value. It contains 70% recycled material, making it a greener product than fiberglass; common means 100 to insulate cracks 128 with mineral wool 70; the resultant wall 103 after exposure 105 to flame or high heat 103 the common means 100 to insulate cracks 128 with mineral wool 70; an exposure 105 to flame or high heat; fire 107; flame and smoke 110 of a fire 107; wall opening 120 or joint 120A with cracks/apertures 128 where flame and smoke 110 can infiltrate a wall system 125; and a wall system 125.

The improved rapid expansion fire stop and system 30 for wall openings 120 anticipates being used with various wall For example, and not as a limitation, these wall types types, include:

| Item | Wall Type for Use of the system 30 |
|---|---|
| 1 | Precast Concrete walls |
| 2 | Concrete Masonry units (CMUs) |
| 3 | Tilt-up walls made with steel reinforced concrete |
| | walls |
| 4 | steel reinforced concrete walls |
| 5 | Metal and glass walls at thermal expansion point |
| 6 | Wood stud walls at thermal expansion joints |

With this description it is to be understood that the improved rapid expansion fire stop and system 30 for wall openings 120 is not to be limited to only the disclosed embodiment of product. The features of the present improved rapid expansion fire stop and system 30 for wall openings 120 are intended to cover various modifications and equivalent arrangements included within the spirit and scope of the description.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

The present invention contemplates modifications as would occur to those skilled in the art. While the disclosure has been illustrated and described in detail in the figures and the foregoing description, the same is to be considered as illustrative and not restrictive in character, it being understood that only selected embodiments have been shown and described and that all changes, modifications and equivalents that come within the spirit of the disclosures described heretofore and or/defined by the following claims are desired to be protected.

What is claimed is:

1. An improved rapid expansion fire stop system (30) for wall openings (120) wall types (125) comprising:
(a) a backer rod (40) comprised of a durable foam material in a pre-determined size with a predetermined cross-sectional configuration, the backer rod having an aperture/slot (41) in the foam (40); and
(b) an intumescent strip (50) with characteristics of expanding thirty-three times its size/volume when exposed to high heat or flame
wherein when a wall (125) made of durable material has been constructed and has an opening (120) and crack (128) such as an expansion joint, the improved expanding rapid expansion fire stop (30) serves as a fire stop to fire, smoke, and heat by expanding and fully sealing the wall opening (120) and crack (128) from any intrusion and passage of the heat, smoke or flame through the opening (120).

2. An improved rapid expansion fire stop system (30) for wall openings (120) as described in claim 1 wherein the predetermined cross-sectional configuration backer rod (40) is selected from the group consisting of a triangle (301), a circle (302), a rectangle (303), a square (304), a pentagon (305), a hexagon (306), an ellipse (307) and an octagon (308).

3. An improved rapid expansion fire stop system (30) for wall openings (120) as described in claim 1 wherein the material type for the intumescent strip (50) is selected from the group consisting of Hydrated sodium silicate, Intercalated graphite, and Ammonium phosphate.

4. An improved rapid expansion fire stop system (30) for wall openings (120) as described in claim 1 wherein the wall type (125) is selected from the group consisting of Precast Concrete, Concrete Masonry units (CMUs), Tilt-up with steel reinforced concrete, steel reinforced concrete walls, metal and glass walls at thermal expansion joints, and wood stud walls at thermal expansion joints.

5. An improved rapid expansion fire stop system (30) for wall openings (120) as described in claim 1 further comprised of an architectural sealant (60).

6. An improved rapid expansion fire stop system (30) for wall openings (120) as described in claim 5 wherein the architectural sealant (60) is selected from the group consisting of water based Latex, Acrylic, Butyl, Polysulfide, Silicone, Poly-isobutylenes, and Polyurethane.

7. An improved rapid expansion fire stop system (30A) for wall openings (120) wall types (125) comprising:
(a) a backer rod (40) comprised of a durable foam material in a pre-determined size with a predetermined cross-sectional configuration, the backer rod having an aperture/slot (41) in the foam (40); and
(b) an intumescent strip (50) with an extended portion (50A) and with characteristics of expanding thirty-three times its size/volume when exposed to high heat or flame wherein the extended portion (50A) wraps up and around the foam (40) to create a “U” shaped assembly
wherein when a wall (125) made of durable material has been constructed and has an opening (120) and crack (128) such as an expansion joint, the improved expanding rapid expansion fire stop (30A) serves as a fire stop to fire, smoke, and heat by expanding and fully sealing the wall opening (120) and crack (128) from any intrusion and passage of the heat, smoke or flame through the opening (120).

8. An improved rapid expansion fire stop system (30A) for wall openings (120) as described in claim 7 wherein the predetermined cross-sectional configuration backer rod (40) is selected from the group consisting of a triangle (301), a circle (302), a rectangle (303), a square (304), a pentagon (305), a hexagon (306), an ellipse (307) and an octagon (308).

9. An improved rapid expansion fire stop system (30) for wall openings (120) as described in claim 7 wherein the material type for the intumescent strip (50) and extension (50B) is selected from the group consisting of Hydrated sodium silicate, Intercalated graphite, and Ammonium phosphate.

10. An improved rapid expansion fire stop system (30A) for wall openings (120) as described in claim 7 wherein the wall type (125) is selected from the group consisting of Precast Concrete, Concrete Masonry units (CMUs), Tilt-up with steel reinforced concrete, steel reinforced concrete walls, metal and glass walls at thermal expansion joints, and wood stud walls at thermal expansion joints.

11. An improved rapid expansion fire stop system (30A) for wall openings (120) as described in claim 7 further comprised of an architectural sealant (60).

12. An improved rapid expansion fire stop system (30A) for wall openings (120) as described in claim 11 wherein the architectural sealant (60) is selected from the group consisting of water based Latex, Acrylic, Butyl, Polysulfide, Silicone, Poly-isobutylenes, and Polyurethane.

13. An improved rapid expansion fire stop system (30B) for wall openings (120) wall types (125) comprising:
(a) a backer rod (40) comprised of a durable foam material in a pre-determined size with a predetermined cross-sectional configuration, the backer rod having an aperture/slot (41) in the foam (40); and
(b) an intumescent wraparound (50B) with characteristics of expanding thirty-three times its size/volume when exposed to high heat or flame wherein the wraparound portion (50B) wraps up and around the foam (40) to create a “U” shaped assembly
wherein when a wall (125) made of durable material has been constructed and has an opening (120) and crack (128) such as an expansion joint, the improved expanding rapid expansion fire stop (30B) serves as a fire stop to fire, smoke, and heat by expanding and fully sealing the wall opening (120) and crack (128) from any intrusion and passage of the heat, smoke or flame through the opening (120).

14. An improved rapid expansion fire stop system (30B) for wall openings (120) as described in claim 13 wherein the predetermined cross-sectional configuration backer rod (40) is selected from the group consisting of a triangle (301), a circle (302), a rectangle (303), a square (304), a pentagon (305), a hexagon (306), an ellipse (307) and an octagon (308).

15. An improved rapid expansion fire stop system (30B) for wall openings (120) as described in claim 13 wherein the material type for the intumescent wraparound (50B) is selected from the group consisting of Hydrated sodium silicate, Intercalated graphite, and Ammonium phosphate.

16. An improved rapid expansion fire stop system (30B) for wall openings (120) as described in claim 13 wherein the wall type (125) is selected from the group consisting of Precast Concrete, Concrete Masonry units (CMUs), Tilt-up with steel reinforced concrete, steel reinforced concrete walls, metal and glass walls at thermal expansion joints, and wood stud walls at thermal expansion joints.

17. An improved rapid expansion fire stop system (30B) for wall openings (120) as described in claim 13 further comprised of an architectural sealant (60).

18. An improved rapid expansion fire stop system (30B) for wall openings (120) as described in claim 17 wherein the architectural sealant (60) is selected from the group consisting of water based Latex, Acrylic, Butyl, Polysulfide, Silicone, Poly-isobutylenes, and Polyurethane.
